(19) United States
(12) Patent Application Publication
(10) Pub. No.: US 2014/0226557 A1
(43) Pub. Date: Aug. 14, 2014

(54) METHOD FOR UPDATING IDENTIFIER OF MULTICAST SERVICE, AND TERMINAL AND BASE STATION ADOPTING SAME

(71) Applicants: Eunjong Lee, Anyang-si (KR); Youngsoo Yuk, Anyang-si (KR); Giwon Park, Anyang-si (KR)

(72) Inventors: Eunjong Lee, Anyang-si (KR); Youngsoo Yuk, Anyang-si (KR); Giwon Park, Anyang-si (KR)

(73) Assignee: LG ELECTRONICS INC., Seoul (KR)

(21) Appl. No.: 14/344,003

(22) PCT Filed: Mar. 30, 2012
(86) PCT No.: PCT/KR2012/002424

§ 371 Date: Mar. 10, 2014

Related U.S. Application Data
(60) Provisional application No. 61/535,948, filed on Sep. 17, 2011.
(60) Provisional application No. 61/535,967, filed on Sep. 17, 2011.

(51) Int. Cl. H04W 4/08

(52) U.S. Cl. CPC H04W 4/08
USPC 370/312

(57) ABSTRACT

Disclosed are a method in which, when an M2M terminal transmits and receives data using an M2M Group ID (MGID) in a broadband wireless communication system which supports M2M communication, a terminal updates an allocated MGID to a new MGID to be reliable, and a terminal and base station for adopting the same. According to one embodiment disclosed in the present invention, a method for updating an identifier to allow a terminal to identify a multicast service shared by group terminals in a group zone during an idle state in a wireless access system includes the steps of: receiving a message including a parameter associated with an updated identifier from a base station; updating an identifier on the basis of the updated identifier; and allowing the base station to transmit a confirmation message for reporting that the message, including the parameter, has been received.

### FIELD OF THE INVENTION

The present invention relates to a method for updating an identifier capable of identifying a multicast service, and a user equipment (UE) and base station (BS) for use in the same.

### BACKGROUND ART

M2M Communication, Machine Type Communication: MTC

M2M communication will hereinafter be described in brief.

Machine-to-machine (M2M) communication is communication between electronic devices as the name implies. That is, M2M communication is an abbreviation of Machine to Machine communication. While M2M communication means wired or wireless communication between electronic devices or communication between a human-controlled device and a machine in the broadest sense, these days M2M communication typically refers to wireless communication between electronic devices. In addition, M2M UEs used in a cellular network have lower throughput than general UEs.

Many UEs are present per cell, such that the UEs can be classified according to UE types, class, service types, etc.

For example, UEs can be classified into a Human Type Communication (HTC) UE and a Machine Type Communication (MTC) UE. In this case, HTC means that signal transmission is decided by a human so as to implement signal transmission/reception. MTC means that each device performs periodic signal transmission due to the occurrence of event without human intervention.

In addition, considering M2M communication or MTC, a total number of UEs can be abruptly increased. M2M UEs have the following characteristics according to supported services.

1. Many UEs existing in a cell

2. A small amount of data.

3. Low transmission frequency (Periodicity)

4. Limited number of data properties

5. Not sensitive to time delay

6. M2M UE may have low mobility or be fixed.

In addition, M2M communication or MTC is applicable to various technical fields such as a protected access and surveillance, tracking and tracking, public safety (e.g., emergency situation, disaster, etc.), payment (e.g., vending machine, ticket machine, parking meter, etc.), healthcare, remote control, smart meter, etc.

Idle Mode

According to the idle mode, the UE can receive a downlink broadcast message at regular intervals without being registered with a specific base station (BS) even when the UE moves in a radio link environment within which a plurality of BSs is present over a broad area.

In the idle mode, not only a handover (HO) operation but also all normal operations are deactivated while only downlink synchronization is achieved to enable reception of a paging message, which is a broadcast message, only within a specific interval. The paging message instructs the UE to perform a paging action. For example, the paging action includes ranging and network reentry.

The idle mode may be initiated by the UE or the BS. That is, the UE may enter the idle mode by transmitting a deregistration request (DREG-REQ) message to the BS and receiving a deregistration response (DREG-RSP) message from the BS in response to the DREG-REQ message. The BS may also enter the idle mode by transmitting an unsolicited deregistration response (DREG-RSP) message or a deregistration command (DREG-CMD) to the UE in response to the DREG-REQ message.

When the UE has received a paging message corresponding to the UE during an Available Interval (AI) in the idle mode, the UE switches to a connected mode through a network entry procedure with the BS to transmit and receive data to and from the BS.

### DETAILED DESCRIPTION OF THE INVENTION

### Technical Problem

An object of the present invention is to provide, when an M2M UE transmits and receives data using an M2M group ID (MGID) in a broadband wireless communication system supporting M2M communication, a method and apparatus for updating a new MGID to trust an MGID allocated to the M2M UE, and a UE and BS for implementing the same.

### Technical Solution

The object of the present invention can be achieved by providing a method for allowing a user equipment (UE) to update an identifier of a multicast service shared by group UEs contained in a group zone during an idle state in a wireless access system, including: receiving a message including a parameter associated with an updated identifier from a base station (BS); updating an identifier based on the updated identifier; and transmitting a confirmation message indicating reception of the message including the parameter to the BS.

Alternatively or additionally, the confirmation message may be transferred through an MSG-ACK message.

Alternatively or additionally, the message including the parameter may be a message related to a location update.

Alternatively or additionally, the message including the parameter may be a message related to a paging.

Alternatively or additionally, the message including the parameter may further include an indicator for updating the identifier.

Alternatively or additionally, the transmitting step may include: transmitting the confirmation message before expiration of a timer started by reception of the message including the parameter.

In accordance with another aspect of the present invention, a method for allowing a base station (BS) to update an identifier of a multicast service shared by group UEs contained in a group zone in a wireless access system includes: updating the identifier in case of a location update or a network reentry; transmitting a message including a parameter associated with the updated identifier to a UE; and receiving a confirmation message indicating reception of the message including the parameter from the UE.

Alternatively or additionally, the method may further include: if the confirmation message is not received, retransmitting the message including the parameter associated with the updated identifier.

Alternatively or additionally, the transmitting step may include: if the confirmation message is not received before expiration of a timer started by transmission of the message including the parameter, retransmitting the message including the parameter associated with the updated identifier to the UE.

Alternatively or additionally, the method may further include: receiving a request message associated with the location update from the UE.

Alternatively or additionally, the method may further include: allocating resources for the confirmation message.

Alternatively or additionally, the confirmation message may be transferred through an MSG-ACK message.

Alternatively or additionally, the message including the parameter may be a message related to a location update.

Alternatively or additionally, the message including the parameter may be a message related to a paging.

Alternatively or additionally, the message including the parameter further may include an indicator for updating the identifier.

In accordance with another aspect of the present invention, a user equipment (UE) device for updating an identifier of a multicast service shared by group UEs contained in a group zone during an idle state in a wireless access system includes: a radio frequency (RF) unit; and a controller connected to the RF unit, wherein the controller controls the RF unit to receive a message including a parameter associated with an updated identifier from a base station (BS), update an identifier based on the updated identifier, and transmit a confirmation message indicating reception of the message including the parameter.

### Effects of the Invention

As is apparent from the above description, according to the embodiments of the present invention, when the M2M UE transmits and receives using M2M Group ID (MGID), the M2M UE can update the allocated MGID without errors. Specifically, if the M2M UE of the idle mode updates MGID through location update, the BS can confirm reception or non-reception of a new MGID, resulting in a guarantee of reliability of MGID update.

### BRIEF DESCRIPTION OF THE DRAWINGS

FIG. 1 is a conceptual diagram illustrating a wireless communication system.

FIG. 2 is a block diagram illustrating a UE (MS) and a BS for use in a wireless access system.

FIG. 3 is a flowchart illustrating an initial access method for use in a wireless communication system.

FIG. 4 is a conceptual diagram illustrating a situation in which an M2M UE has to update M2M Group Identifier (MGID).

FIG. 5 is a flowchart illustrating an MGID update process according to a first embodiment.

FIG. 6 is a flowchart illustrating an MGID update process according to a second embodiment.

FIG. 7 is a flowchart illustrating an MGID update process according to a third embodiment.

FIG. 8 is a flowchart illustrating an MGID update process according to a fourth embodiment.

FIG. 9 is a flowchart illustrating an MGID update process according to a fifth embodiment.

FIG. 10 is a flowchart illustrating an MGID update process according to a sixth embodiment.

### BEST MODE FOR CARRYING OUT THE INVENTION

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. The following embodiments of the present invention can be applied to a variety of wireless communication technologies, for example, CDMA, FDMA, TDMA, OFDMA, SC-FDMA, and the like. CDMA can be implemented by wireless communication technologies, such as Universal Terrestrial Radio Access (UTRA) or CDMA2000. TDMA can be implemented by wireless communication technologies, for example, Global System for Mobile communications (GSM), General Packet Radio Service (GPRS), Enhanced Data rates for GSM Evolution (EDGE), etc. OFDMA can be implemented by wireless communication technologies, for example, IEEE 802.11 (Wi-Fi), IEEE 802.16 (WiMAX), IEEE 802.20, E-UTRA (Evolved UTRA), and the like. IEEE 802.16m is evolved from IEEE 802.16e, and provides backward compatibility with the IEEE 802.16e system. IEEE 802.16p provides a communication standard for supporting Machine Type Communication (MTC).

UTRA is a part of the Universal Mobile Telecommunications System (UMTS). 3rd Generation Partnership Project (3GPP) Long Term Evolution (LTE) is a part of Evolved UMTS (E-UMTS) that uses E-UTRA. 3GPP LTE employs OFDMA in downlink and employs SC-FDMA in uplink. LTE-Advanced (LTE-A) is an evolved version of 3GPP LTE.

Although the following embodiments of the present invention will hereinafter describe inventive technical characteristics on the basis of IEEE 802.16m, it should be noted that the following embodiments will be disclosed only for illustrative purposes and the scope and spirit of the present invention are not limited thereto.

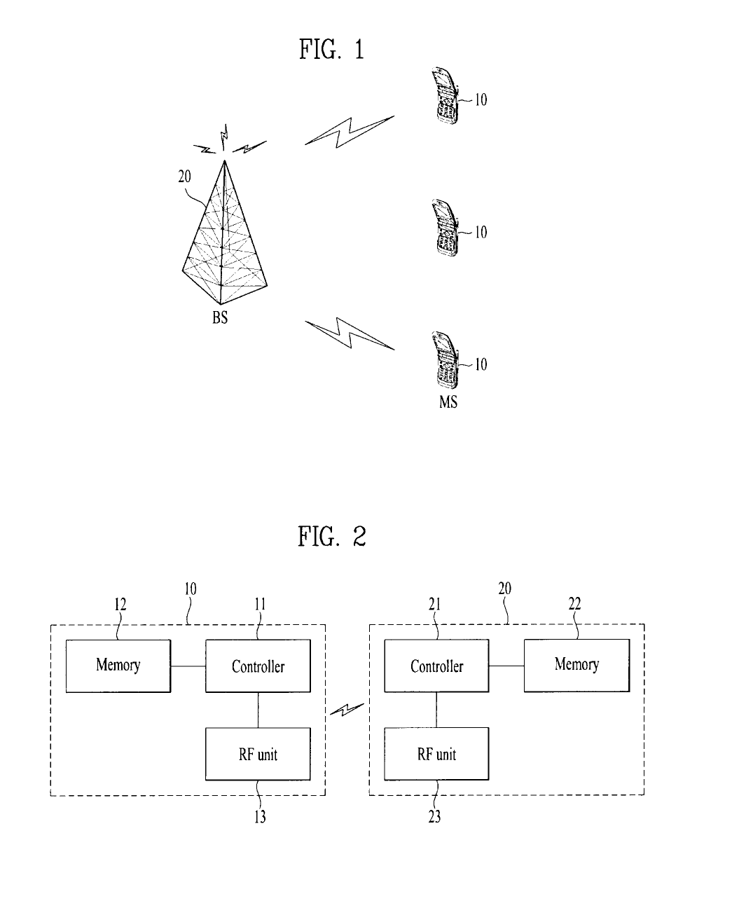

FIG. 1—Wireless Communication System

FIG. 1 is a block diagram illustrating a wireless communication system according to an embodiment of the present invention.

A wireless communication system is widely deployed to provide a variety of communication services such as voice, packet data, etc.

Referring to FIG. 1, a wireless communication system includes a mobile station (MS) and a base station (BS). The MS denotes a mobile or fixed type MS. The MS may be referred to as, a User Equipment (UE), a User Terminal (UT), a Subscriber Station (SS), a Wireless Device, an Advanced Mobile Station (AMS), or the like.

The Base Station (BS) means a fixed station that performs communication with the MS 10. The BS 20 may be referred to by another term such as an evolved-NodeB (eNB), a Base Transceiver System (BTS), and an Access Point (AP). One BS 20 includes one or more cells.

The wireless communication system may be an OFDM or OFDMA based system.

OFDM uses a plurality of orthogonal subcarriers. OFDM uses orthogonal characteristics between IFFT (Inverse Fast Fourier Transform) and FFT (Fast Fourier Transform). The transmitter performs IFFT processing of data and transmits the IFFT-processed data. The receiver recovers original data by performing FFT on a received signal. The transmitter performs IFFT to combine multiple subcarriers, and performs FFT to isolate multiple subcarriers from each other.

In addition, the slot is a minimum data allocation unit, and is composed of a time and a subchannel. In uplink, the subchannel may be composed of a plurality of tiles. The subchannel may be composed of 6 tiles. In uplink, one burst may be composed of 3 OFDM symbols and one subchannel.

In Partial Usage of Subchannels (PUSC) permutation, each tile may include four contiguous subcarriers on 3 OFDM symbols. Selectively, each tile may include three contiguous subcarriers on 3 OFDM symbols. A bin includes 9 contiguous subcarriers on an OFDM symbol. A band refers to a group of 4 rows of the bin, and an AMC (Adaptive Modulation and Coding) subchannel includes 6 contiguous bins in the same band.

FIG. 2—Block Diagram of MS and BS

FIG. 2 is a block diagram illustrating a base station (BS) and a mobile station (MS) for use in a wireless access system according to an embodiment of the present invention.

Referring to FIG. 2, the MS 10 includes a controller 11, a memory 12, and a radio frequency (RF) unit 13.

In addition, the MS 10 includes a display unit, a user interface unit, etc.

The controller 11 may be constructed to implement the functions, procedures and/or methods disclosed in the embodiments of the present invention. Layers of the radio interface protocol may be implemented by the controller 11.

The memory 12 may be connected to the controller 11, and store various protocols or parameters for RF communication. That is, the memory 12 stores an MS drive system, and application and general files.

The RF unit 13 is connected to the controller 11, and transmits and/or receives RF signals.

In addition, the display unit may display various pieces of information of the MS and be a Liquid Crystal Display (LCD), an Organic Light Emitting Diode (OLED), etc. which are known in the art. The user interface unit may be configured to be combined with a known user interface such as a keypad, a touch screen, or the like.

The BS 20 includes a controller 21, a memory 22, and an RF unit 23.

The controller 21 may be constructed to implement the functions, procedures and/or methods disclosed in the embodiments of the present invention. Layers of the radio interface protocol may be implemented by the controller 21.

The memory 22 may be connected to the controller 21, and store various protocols or parameters for RF communication.

The RF unit 23 is connected to the controller 21, and transmits and/or receives RF signals.

The controllers 11 and 21 may include Application-Specific Integrated Circuits (ASICs), other chipsets, logic circuits, and/or data processors. The memory 12 and 22 may include Read-Only Memories (ROMs), Random Access Memories (RAMs), flash memories, memory cards, storage media, and/or other storage devices. The RF units 13 and 23 may include baseband circuits for processing radio signals. When the embodiments are implemented in software, the above methods may be implemented using modules (processes or functions) for performing the above functions. The modules may be stored in the memories 12 and 22 and executed by the processors 11 and 21.

The memories 12 and 22 may be placed inside or outside the controllers 11 and 21 and may be coupled to the controllers 11 and 21 by a variety of well-known means.

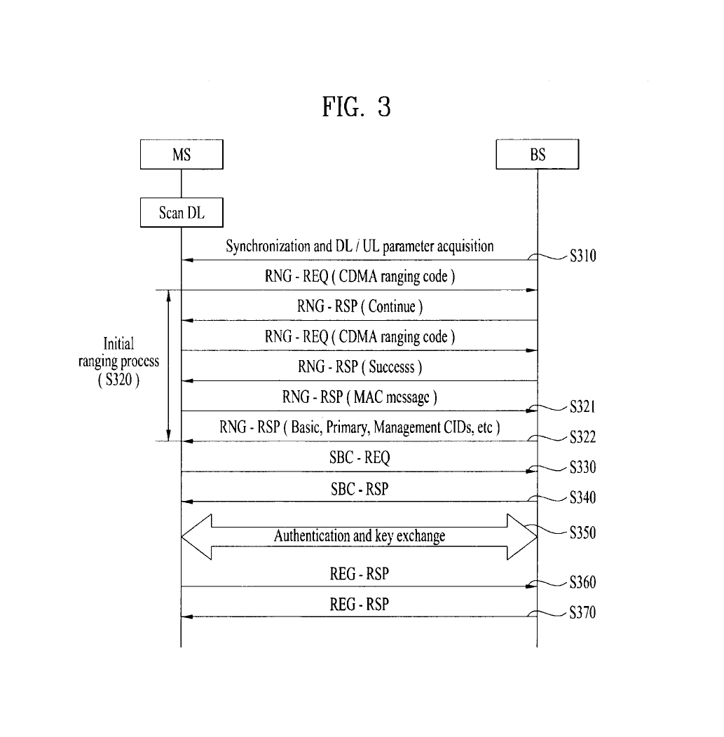

FIG. 3—Block Diagram of MS and BS

FIG. 3 is a flowchart illustrating an initial access method for use in a wireless communication system.

Referring to FIG. 3, the MS is powered on, and searches for an accessible BS by scanning a downlink channel so as to perform initial access. Since the MS does not have initial network geographical or configuration information, all DL channels (or frequencies) of neighbor BSs need to be scanned.

The MS 10 obtains DL and UL system information from the searched BS 20 and thus completes all system configurations in step S310. The MS can perform ranging with the searched BS as shown in FIG. 3. The MS selects an arbitrary CDMA ranging code so that the MS performs ranging with the BS using the contention-based method in step S320.

The BS transmits an RNG-RSP message to the BS, so that it can inform the MS of a plurality of variable values to be amended by the MS until reaching complete synchronization. In this case, during amendment of the variable values, the RNG-RSP status may be established as a continue status. After completion of the amendment of the variable values, the BS transmits the RNG-RSP message having a success status.

In this case, the RNG-RSP message transferred from the BS to the MS 10 may include MS power offset information calculated by the BS on the basis of the RNG-REQ code received from the MS, timing offset information, and data Tx/Rx frequency offset information. Thereafter, the MS may transmit data to the BS on the basis of the above information.

After the RNG-REQ message caused by the ranging code has been successfully carried out by the RNG-RSP message, the MS transmits the RNG-REQ message to the BS in step 321, and the BS transmits the RNG-RSP message to the MS in step S322.

Upon receiving the RNG-RSP message from the BS, the MS transmits a subscriber station basic capability request (SBC-REQ) message including not only various parameters supportable by the UE for data transmission/reception to/from the BS but also information regarding an authentication scheme to the BS in step S330.

Upon receiving the SBC-REQ message from the MS, the BS compares the parameters and authentication scheme contained in the SBC-REQ message supported by the UE with other parameters and authentication scheme supported by the BS. In accordance with this comparison result, the BS decides the parameters and authentication scheme to be used by the MS for data transmission/reception, and the BS transmits the SBC-RSP (Subscriber station Basic Capability Response) message including the above parameters and authentication scheme to the MS in step S340.

The MS completes basic capability negotiation with the BS, and then performs an authentication procedure with the BS. That is, the MS authenticates the BS, the BS authenticates the MS, and the MS and the BS exchange an authorization key with each other in step S350.

Thereafter, the MS exchanges a registration request (REG-REQ) message and a registration response (REG-RSP) message with the BS such that the BS registration procedure is performed in steps S360 and S370.

After completion of registration between the MS and the BS, IP connectivity is established, a time of day is established, and other action parameters are transmitted. As a result, connection between the MS and the BS is set up.

M2M communication

M2M communication will hereinafter be described in brief.

Machine-to-machine (M2M) communication is communication between electronic devices as the name implies. That is, M2M communication is an abbreviation of Machine to Machine communication. While M2M communication means wired or wireless communication between electronic devices or communication between a human-controlled device and a machine in the broadest sense, these days M2M communication typically refers to wireless communication between electronic devices. In addition, M2M UEs used in a cellular network have lower throughput than general UEs.

In addition, the M2M environment has the following characteristics.

1. Many UEs existing in a cell

2. A small amount of data.

3. Low transmission frequency (Periodicity)

4. Limited number of data properties

5. Not sensitive to time delay

Many UEs are present per cell, such that the UEs can be classified according to UE types, class, service types, etc. Specifically, considering M2M communication or MTC, a total number of UEs can be abruptly increased. M2M UEs have the following characteristics according to supported services.

1. M2M UEs intermittently transmit data. The M2M UEs may have periodicity.

2. The M2M UEs have low mobility or are fixed.

3. The M2M UEs are insensitive to latency in signal transmission.

M2M UEs having the above characteristics in a cell can transmit or receive signals to/from a BS or other terminals using a multi-hop configuration or a hierarchical structure.

That is, an M2M UE may receive a signal from the BS and transmit the received signal to an M2M UE located at a different layer or a lower layer, or receive a signal from other M2M UEs and transmit the signal to other M2M UEs or the BS. Otherwise, direct communication between M2M UEs may be performed without using a relay.

For signal transmission between M2M UEs, the M2M UEs may be connected in an upper/lower structure to transmit signals (although the upper/lower structure may not be employed in the case of direct communication between UEs, signal transmission may be described by applying the upper/lower structure to the direct communication between UEs).

In downlink transmission, for example, mobile station (MS) 1 receives a signal from the BS and transmits the received signal to MS 2. Here, MS 1 may transmit the signal to a lower MS as well as MS 2. MS 2 is a lower terminal of MS 1.

Upon reception of the signal from MS 1, MS 2 transmits the received signal to a lower MS. In this manner, the signal is transmitted to MS N. In this case, many UEs may be connected in a multi-hop or hierarchical structure between MS 2 and MS N.

Alternatively, in uplink transmission, signal transmission between M2M UEs may be performed as follows. A lower M2M UE may transmit a signal to another M2M UE or the BS using a higher M2M UE.

Terms to be used in an M2M system are defined as follows.

(1) Machine-to-Machine (M2M) communication: information exchange between user devices through a base station (BS) or between a server and a device in a core network through a base station (BS), performed without human intervention.

(2) M2M ASN: access service network capable of supporting the M2M service.

(3) M2M device: UE or terminal having (or supporting) the M2M function.

(4) M2M subscriber: M2M service user equipment (UE).

(5) M2M server: entity capable of communicating with an M2M device, which provides an interface accessible by an M2M subscriber.

(6) M2M feature: feature of an M2M application supported by M2M ASN. One or more features may be needed to support the M2M application.

(7) M2M group: group of M2M UEs including a common M2M subscriber and/or the same M2M subscriber, that is, sharing one or more features.

Although the 802.16 (specifically, 16 m) system is disclosed only for illustrative purposes, a method of the embodiment is not limited to the 802.16m system, and can also be applied to various systems such as LTE, LTE-A, etc.

Definition of M2M Group ID (MGID), MGID Zone ID, and M2M UE (or M2M Device) ID (MDID)

M2M UEs according to the embodiments may belong to one or more M2M groups. The M2M group is a group of M2M UEs sharing one or more features. For example, the M2M group may be a set of UEs receiving a specific application service. Each M2M group may be assigned an M2M group ID (MGID). MGID can uniquely identify a specific M2M group in the network entity.

MGID is allocated by a network entity. Through a dynamic service change (DSA) process after completion of an initial network entry, the MGID may be allocated by a service flow of the M2M UE. The allocated MGID is maintained in the M2M UE so long as M2M UE escapes from the network coverage or the network does not delete the service flow associated with MGID. Alternatively, MGID may be changed through a DSC process.

In the system supporting M2M communication, MGID for indicating the M2M group including each M2M UE and an M2M device ID for identifying M2M UEs contained in the M2M group are allocated to M2M devices.

In this case, MGID is an identifier for identifying each M2M group in the cell, and M2M device ID is an identifier for identifying each M2M device in a group having the M2M device.

During the initial network entry process, M2M UEs may be assigned an M2M Group ID and M2M device ID to be used for communication with the BS from the M2M communication supporting system. In this case, the M2M communication supporting system refers to a network entity connected to the BS or the network. For example, the network entity may be an M2M server.

The M2M group zone identifier is an identifier for identifying a network entity to which MGID is allocated. One or more BSs may be contained in one M2M group, and one BS may belong to one or more M2M groups. The same relationship of mapping between the service flow and the MGID is achieved in one M2M group, and the relationship of mapping the service flow and the MGID may be differently established in different M2M groups. In individual group zones having different MGID Zone IDs, MGID may be independently managed.

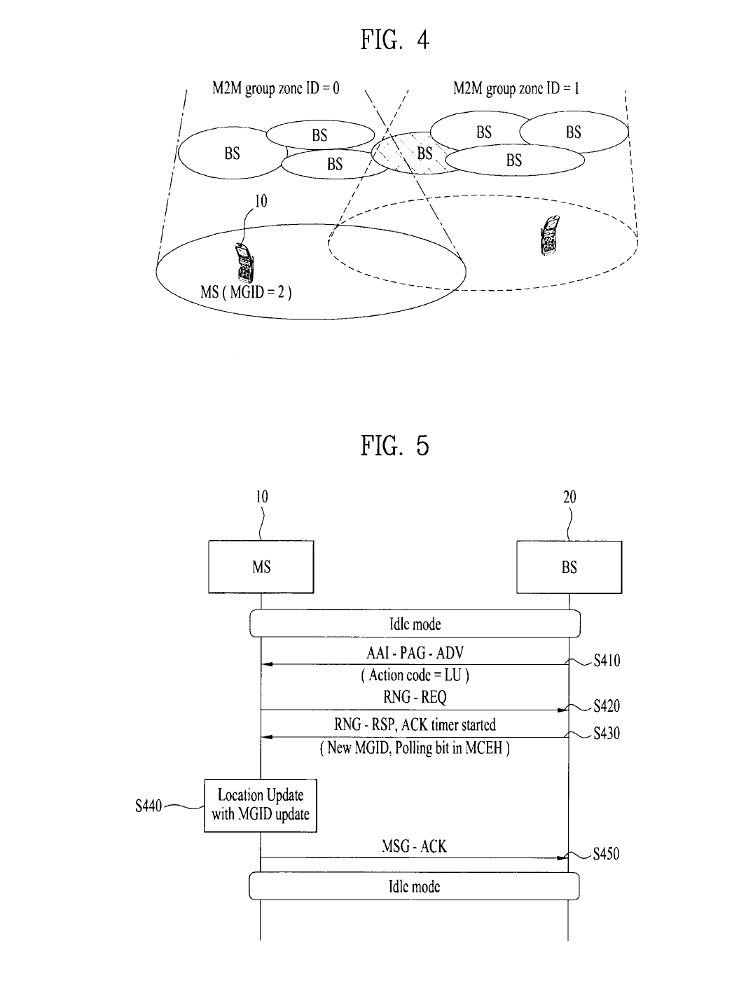

FIG. 4—Relationship Between M2M Group ID and M2M Device ID

FIG. 4 is a conceptual diagram illustrating a situation in which an M2M UE has to update M2M Group Identifier (MGID).

Each BS may belong to a specific M2M group zone. Individual BSs shown in FIG. 4 may belong not only to the M2M group zone having “ID=0” but also to the M2M group zone having “ID=1”.

Assuming that the M2M UE moves from the M2M group zone of ID=0 to the other M2M group zone of ID=1, MGIDs supported by individual M2M group zones may be different from each other.

If MGIDs supported by the M2M group zone are different from each other, i.e., if M2M UE to which MGID is allocated escapes from the M2M group zone having a valid MGID, the UE and the network recognize this situation, and must perform updating to MGID appropriate for the changed M2M group zone.

Referring to FIG. 4, while “MGID=2” of a specific service flow (e.g., transportation information, traffic map information) is allocated to the M2M group zone having “ID=0”, MGID=3 for the same service flow may be allocated to the M2M group zone having “ID=1”. In this case, the UE can receive correct data only when MGID is updated.

Related Technology

MGID is an M2M group ID composed of 15 bits. In order to uniquely identify M2M group contained in a domain of the network entity to which MGID is allocated. One or more M2M devices may belong to M2M Group.

MGID is allocated to the service flow of the M2M device through the DSA process after completion of the initial network entry by the network entity, and may be released when the explicit network exit or the DCR mode starts. If the M2M device does not escape from the network coverage or the network does not delete the service flow explicitly associated with MGID, the allocated MGID may be maintained by the M2M device even in the idle mode. MGID may be re-allocated for a connected state or an idle state. During the connected state, MGID may be changed by the DSC process, and may be deleted by the DSD process. In a step for adding connection, flow may be mapped to MGID, and MGID may be released when flow is deleted.

During the idle state, MGID may be changed either by location update (i.e., M2M device—initiation location update or BS-initiation location update) or by a network entry. When the BS updates MGID through the BS-initiation location update, the BS may trigger not only each location update but also group location update. When the BS changes MGID of all M2M devices of the multicast group, the BS may trigger group location update through the paging message. When the M2M device performs timer-based update and the BS needs to update MGID of the M2M device, the AAI-RNG-RSP message having a new MGID may be transmitted from the BS in response to the AAI-RNG-REQ message. In addition, MGID may be updated through the RNG-RSP message during handover.

If the transmitted control message does not have a response message, or if the transmitted control message does not request reliable transmission instead of immediate response, the transmitter commands the receiver to transmit a MAC layer confirmation message for deciding a state of the transmitted control message. When MAC layer confirmation is used, the transmitter may determine the polling bit contained in MCEH of MACPDU including a complete control message or the last pending part of a control message to be ‘1’. In order to wait for the AAI-MSG-ACK message or the MAC ACK extended header, the transmitter may immediately begin to operate the ACK timer after transmission of the MACPDU in which the polling bit of MCEH is set to ‘1’. Upon receiving a regional NACK for MACPDU through which MCEH transmits the polling bit of 1, the MCEH may set the polling bit to ‘1’ during retransmission of the MACPDU having the last pending part. The ACK timer may stop operation upon receiving the regional NACK. The ACK timer stopped by the regional NACK may resume during retransmission of the last pending part. Upon receiving the AAI-MSG-ACK message or the Message ACK extended header from the receiver, the ACK timer stops operation. If the ACK timer has expired or the retransmission timer has expired before receiving the confirmation message, the transmitter may restart retransmission of all messages. The transmitter may stop the ACK timer when the retransmission timer has expired. After the ACK timer or the retransmission timer has expired, if the transmitter starts retransmission, the retransmission timer may be reconfigured.

The following Table 1 shows various fields of the RNG-RSP message used in the following description.

TABLE 1

| Field | Size (bits) | Value/Description | Condition |
|---|---|---|---|
| . . . | | . . . | . . . |
| Indication of | 1 | 1: In case of an initial network | This field may be |
| unsolicited | | entry, for transmission of a BR | included when the |
| bandwidth grant | | header without receiving a UE | UE attempts to |
| | | request during the network | perform network |
| | | entry, an unsolicited bandwidth | entry. During the |
| | | grant is available. In case of a | network reentry from |
| | | network entry, for transmission | the idle mode, if the |
| | | of a BR header without | AAI-RNG-RSP |
| | | receiving an M2M device | message is |
| | | request during the network | transmitted in |
| | | reentry from the idle mode, an | response to the AAI- |
| | | unsolicited bandwidth grant is | RNG-REQ message |
| | | available. | including a |
| | | | bandwidth request |
| | | | indicator, this field |
| | | | may be included. |
| For(i=0; | | Number (Num _MGID) of | If there is a need to |
| i<Num_MGID;i++){ | | MGIDs and FIDs for update in | perform update, this |
| | | T-ABS [1...TBD]. Mapping | field is present. |
| | | current MGID and FID to new | |
| | | MGID and FID to be updated. | |
| Current MGID | 15 | | |
| Current FID | 4 | | |
| New MGID | 15 | | |
| New FID | 4 | | |
| } | | | |
| . . . | | . . . | . . . |
| IF (Location Update | | | |
| Response == 0x0{ | | | |
| . . . | | | |
| New Fixed | 16 | New FMDID in which a fixed | This field is present |
| M2M | | M2M device can be maintained | only in the regional |
| Deregistration | | in the idle mode. | idle mode. The |
| ID | | | permitted flag is set |
| | | | to ‘1’ at AAI-DREG- |
| | | | REQ/RSP messages. |
| . . . | . . . | . . . | . . . |
| } | | | |
| . . . | . . . | . . . | . . . |

MGID update requires reliability. MGID update is provided from the BS. Through the DSC process (DSC-REQ/RSP), the MGID update is provided to the connected-mode UE, and is provided to the idle-mode UE through the location update (RNG-RSP).

If MGID update is provided through the DSC process, and if a new MGID is provided to the DSC-RSP serving as the DSC-REQ response from the UE, the AAI-DSC-ACK message is transmitted to confirm whether the corresponding DSC-RSP message is well received. Accordingly, MGID update of the connected-mode UE can be provided with high reliability.

However, if MGID update is provided through location update for the idle-mode UE, the BS transmits the RNG-RSP message as a response to the RNG-REQ message of the UE. Although a new MGID is transmitted through this message, it is impossible for the BS to confirm whether the UE well receives the RNG-RSP message for new MGID transmission. Accordingly, there is a need to define a method for performing reliable MGID update.

The reliable MGID update method according to the embodiments is classified into two methods, i.e., the location update method and the paging method, and a detailed description thereof will hereinafter be described in detail.

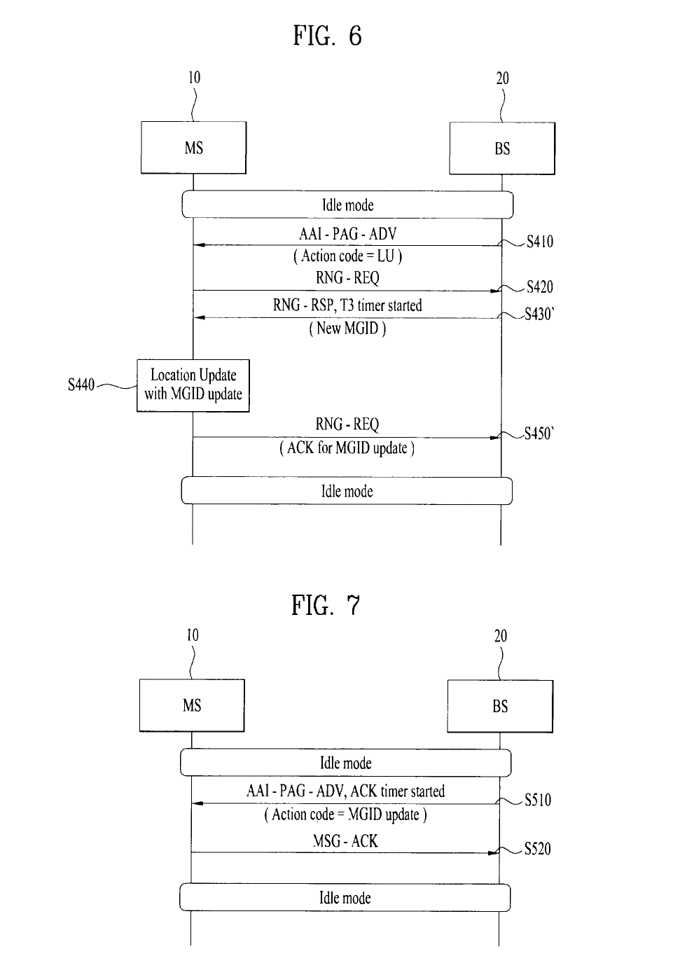

FIGS. 5 and 6—MGID Update Through Location Update

FIG. 5 is a flowchart illustrating an MGID update process according to a first embodiment.

Referring to FIG. 5, the BS 20 can transmit the PAG-ADV message for location update to MSs 10 contained in the M2M group in step S410. In this case, each MS 10 having successfully received the PAG-ADV message may transmit the RNG-REQ message to the BS 20 in step S420.

The BS 20 having received the RNG-REQ message from the MS 10 may transmit the RNG-RSP message including the MGID update associated parameters to be updated to the MS 10 in step 5430. In this case, the ACK timer starts operation.

In this case, the MS 10 performs location update along with MGID update in step S440, and transmits the MSG-ACK indicating successful reception of the RNG-RSP message before expiration of the ACK timer in step S450.

The polling bit of MCEH of the AAI-RNG-RSP message is set to ‘1’ by the MS 10 for MGID update information, and the BS 20 may perform triggering for AAI-MSG-ACK transmission.

The BS may allocate the bandwidth for MSG-ACK through RNG-RSP, or may allocate new bandwidth after transmission of the RNG-RSP message.

FIG. 5 is a flowchart illustrating an MGID update process according to a second embodiment.

Referring to FIG. 5, the BS 20 transmits the PAG-ADV message to MSs 10 of the M2M group for location update in steps S410 and S420, and the MS 10 having successfully received the PAG-ADV message transmits the RNG-REQ message to the BS 20.

The BS 20 may transmit the RNG-RSP message including MGID update associated parameters needed for update of a current MGID to the MS 10 in step S430′. In this case, the T3 timer starts operation.

In this case, the MS 10 performs not only MGID update but also location update in step S440, and transmits the MSG-ACK message indicating successful reception of the RNG-RSP message associated with MGID update before expiration of the T3 timer in step S450′. In this case, the RNG-REQ message serving as an MGID update response message may include MGID update acknowledgement indication information.

The following Table 2 shows all values of the T3 timer.

TABLE 2

| | | | | | Maxi- |
|---|---|---|---|---|---|
| | | Time | Minimum | | mum |
| System | Name | Reference | value | Basic values | value |
| SS, | T3 | Ranging | — | OFDMA: | 200 ms |
| MS | | response | | 60 msec: CDMA | |
| | | reception | | ranging during initial | |
| | | time after | | or periodic ranging, | |
| | | trans- | | or RNG-RSP after | |
| | | mission | | RNG-REQ | |
| | | of | | 50 msec: RNG-RSP | |
| | | ranging | | after RNG-REQ | |
| | | request | | during handover to a | |
| | | | | negotiated target BS | |
| | | | | 200 msec: RNG-RSP | |
| | | | | after RNG-REQ | |
| | | | | during handover to a | |
| | | | | non-negotiated target | |
| | | | | BS | |
| | | | | 200 msec: RNG-RSP | |
| | | | | after RNG-REQ | |
| | | | | during location | |
| | | | | update or reentry | |
| | | | | process from the idle | |
| | | | | mode | |
| | | | | [TBD] msec: | |
| | | | | RNG-REQ after | |
| | | | | RNG-RSP during | |
| | | | | MGID update | |

FIGS. 7 to 10—MGID Update Through Paging Message

FIG. 7 is a flowchart illustrating an MGID update process according to a third embodiment.

Referring to FIG. 7, the BS 20 may transmit the PAG-ADV message including the MGID update associated parameters to be used for current MGID update to the MSs 10 contained in the M2M group in step S510. In this case, the ACK timer may start operation. In this case, all MSs 10 having successfully received the PAG-ADV message perform MGID update, and may transmit the MSG-ACL message indicating successful MGID update before expiration of the ACK timer in step S520.

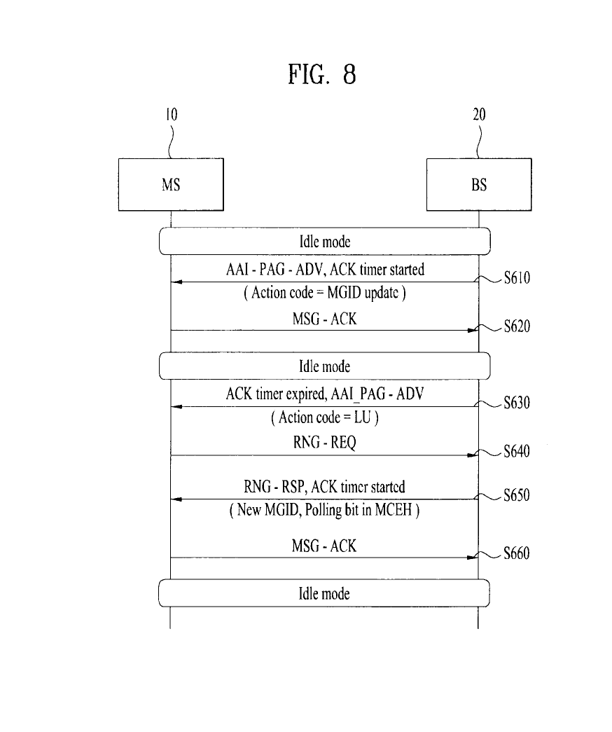

FIG. 8 is a flowchart illustrating an MGID update process according to a fourth embodiment.

Referring to FIG. 8, as shown in steps S510 and S520, the BS 20 may transmit the PAG-ADV message including MGID update associated parameters needed for current MGID update to the MSs 10 contained in the M2M group (in this case, the ACK timer may start operation), all MSs 10 having successfully received the PAG-ADV message perform MGID update, and the MSs transmit the MSG-ACK indicating successful MGID update before expiration of the ACK timer in steps S610 and S620.

If the MS 10 that has not transmitted MSG-ACK until expiration of the ACK timer exists, the BS 20 transmits the PAG-ADV message for location update only to the corresponding UEs, such that MGID can be independently updated.

That is, the BS 20 may transmit the PAG-ADV message for location update to the MSs 10 contained in the M2M group in step S630. In this case, the MS 10 having successfully received the PAG-ADV message may transmit the RNG-REQ message to the BS in step S640.

The BS 20 having received the RNG-REQ message from the MS 10 may transmit the RNG-RSP message including MGID update associated parameters to be used for current MGID update to the MS 10 in step S650. In this case, the ACK timer starts operation.

In this case, the MS 10 performs location update along with MGID update, and transmits the MSG-ACK indicating successful reception of the RNG-RSP message in association with MGID update before expiration of the ACK timer in step S660.

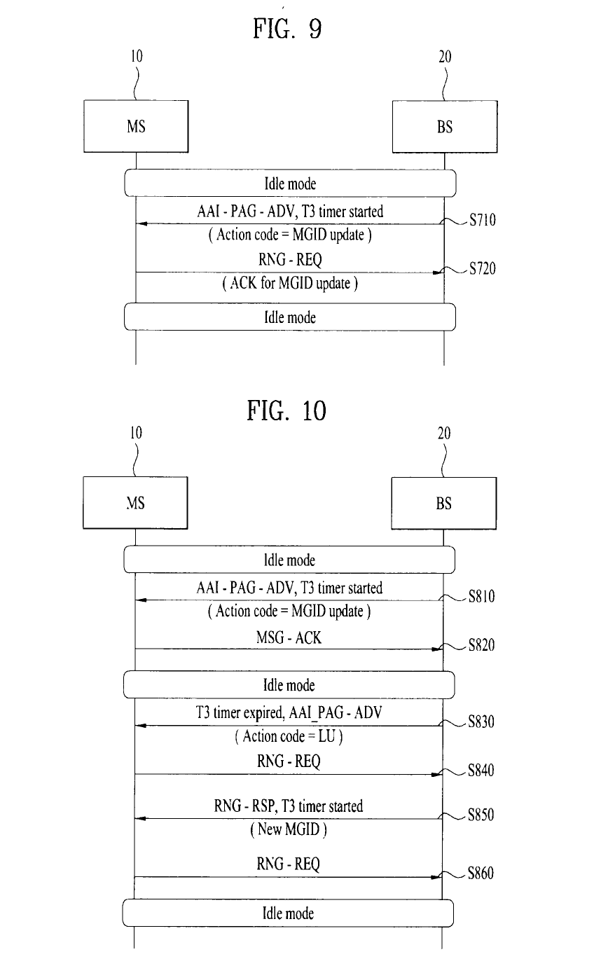

FIG. 9 is a flowchart illustrating an MGID update process according to a fifth embodiment.

Referring to FIG. 9, the BS 20 may transmit the PAG-ADV message including MGID update associated parameters to be used for current MGID update to the MSs 10 contained in the M2M group in step S710. In this case, the T3 timer may start operation.

In this case, all MSs 10 having successfully received the PAG-ADV message transmits in advance the RNG-REQ message indicating successful MGID update before expiration of the T3 timer in step S720.

The following Table 3 shows all values of the T3 timer.

TABLE 3

| | | Time | Minimum | | Maximum |
|---|---|---|---|---|---|
| | Name | Reference | value | Basic values | value |
| SS, | T3 | Ranging | — | OFDMA: | 200 ms |
| MS | | response | | 60 msec: CDMA | |
| | | reception | | ranging during initial | |
| | | time | | or periodic ranging, | |
| | | after | | or RNG-RSP after | |
| | | trans- | | RNG-REQ | |
| | | mission | | 50 msec: RNG-RSP | |
| | | of | | after RNG-REQ | |
| | | ranging | | during handover to a | |
| | | request | | negotiated target BS | |
| | | | | 200 msec: RNG-RSP | |
| | | | | after RNG-REQ | |
| | | | | during handover to a | |
| | | | | non-negotiated target | |
| | | | | BS | |
| | | | | 200 msec: RNG-RSP | |
| | | | | after RNG-REQ | |
| | | | | during location | |
| | | | | update or reentry | |
| | | | | process from the idle | |
| | | | | mode | |
| | | | | [TBD] msec: | |
| | | | | RNG-REQ after | |
| | | | | PAG-ADV during | |
| | | | | MGID update | |

FIG. 10 is a flowchart illustrating an MGID update process according to a sixth embodiment.

Referring to FIG. 9, as shown in steps S710 and S720, the BS 20 may transmit the PAG-ADV message including MGID update associated parameters needed for current MGID update to the MSs 10 contained in the M2M group (in this case, the T3 timer may start operation), all MSs 10 having successfully received the PAG-ADV message perform MGID update, and the MSs transmit the MSG-ACK indicating successful MGID update before expiration of the ACK timer in steps S810 and S820.

If the MS 10 that has not transmitted MSG-ACK until expiration of the ACK timer exist, the BS 20 transmits the PAG-ADV message for location update only to the corresponding UEs, such that MGID can be independently updated.

That is, the BS 20 may transmit the PAG-ADV message for location update to the MSs 10 contained in the M2M group in step S830. In this case, the MS 10 having successfully received the PAG-ADV message may transmit the RNG-REQ message to the BS in step S840.

The BS 20 having received the RNG-REQ message from the MS 10 may transmit the RNG-RSP message including MGID update associated parameters to be used for current MGID update to the MS 10 in step S850. In this case, the T3 timer starts operation.

In this case, the MS 10 performs location update along with MGID update, and transmits the MSG-ACK indicating successful reception of the RNG-RSP message in association with MGID update before expiration of the T3 timer in step S860.

A method for allocating resources to the MSG-ACK or RNG-REQ message for confirmation purposes used in the above-mentioned embodiments may be achieved in various ways. For example, the BS 20 may allocate a bandwidth in an unsolicited manner. In this case, the BS 20 recognizes that the UE will transmit a response message in association with a message transmitted for MGID update purpose. After transmission of the above message (PAG-ADV or RNG-RSP, etc.), bandwidth allocation can be transmitted in an unsolicited manner. In this case, after the MS 10 receives a message of MGID update purpose, the MS can await allocation of a bandwidth received from the BS 20 (BR grant time or T3 timer may be used).

In addition, for example, after the MS 10 requests the bandwidth, the MS receives the bandwidth from the BS 20 and then uses the received bandwidth (according to contention-based method), and the BS 20 may perform bandwidth allocation using a transmission message for MGID update.

In addition, the MSG-ACK or RNG-REQ message for the ACK purpose used in the above embodiments may also be used for MS-initiation location update. For example, if the timer-based location update is performed, the MS 10 transmits the RNG-REQ message, the BS 20 transmits the RNG-RSP message in response to the RNG-REQ message. In this case, MGID update information may be contained in the RNG-RSP message, and the MS has to transmit the response message.

In addition, the MSG-ACK or RNG-REQ message for the ACK purpose according to the embodiments may be omitted during location update as necessary. For example, if the MGID update process according to the fourth embodiment is performed, if the BS does not receive the MSG-ACK message from the MS 10 in response to the AALPAG-ADV message of the MS 20. In this case, the BS 20 independently performs MGID update process through location update. In this case, the BS 20 confirms the MGID update of the MS through the RNG-REQ message received from the MS, and may omit the response message through the MSG-ACK message.

Technical terms used in this specification are used merely to illustrate specific embodiments, and it should be understood that they are not intended to limit the present disclosure. So long as not defined otherwise, all terms used herein including technical terms may have the same meaning as those generally understood by an ordinary person skilled in the art to which the present disclosure pertains, and should not be construed in an excessively comprehensive manner or an extremely restricted manner. In addition, if a technical term used in the description of the present disclosure is an erroneous term that fails to clearly express the idea of the present disclosure, it should be replaced by a technical term that can be properly understood by those skilled in the art. In addition, general terms used in the description of the present disclosure should be construed according to definitions in dictionaries or according to context, and should not be construed in an excessively restrictive manner.

A singular representation may include a plural representation unless the context clearly indicates otherwise. It will be understood that the terms ‘comprising’, ‘include’, etc., when used in this specification, specify the presence of several components or several steps and part of the components or steps may not be included or additional components or steps may further be included.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

It will be understood that when an element is referred to as being “connected with” another element, the element can be directly connected with the other element or intervening elements may also be present. In contrast, when an element is referred to as being “directly connected with” another element, there are no intervening elements present.

Exemplary embodiments of the present invention will be described below in detail with reference to the accompanying drawings in which the same reference numbers are used throughout this specification to refer to the same or like parts. In describing the present invention, a detailed description of known functions and configurations will be omitted when it may obscure the subject matter of the present invention. The accompanying drawings are used to help easily understand the technical idea of the present invention and it should be understood that the idea of the present invention is not limited by the accompanying drawings. The idea of the present invention should be construed to extend to any alterations, equivalents and substitutions besides the accompanying drawings.

1. A method for allowing a user equipment (UE) to update an identifier of a multicast service shared by group UEs contained in a group zone during an idle state in a wireless access system, comprising:
receiving a message including a parameter associated with an updated identifier from a base station (BS);
updating an identifier based on the updated identifier; and
transmitting a confirmation message indicating reception of the message including the parameter to the BS.

2. The method according to claim 1, wherein the confirmation message is transferred through an MSG-ACK message.

3. The method according to claim 1, wherein the message including the parameter is a message related to a location update.

4. The method according to claim 1, wherein the message including the parameter is a message related to a paging.

5. The method according to claim 1, wherein the message including the parameter further includes an indicator for updating the identifier.

6. The method according to claim 1, wherein the transmitting includes:
transmitting the confirmation message before expiration of a timer started by reception of the message including the parameter.

7. A method for allowing a base station (BS) to update an identifier of a multicast service shared by group user equipments (UEs) contained in a group zone in a wireless access system, comprising:
updating the identifier in case of a location update or a network reentry;
transmitting a message including a parameter associated with the updated identifier to a UE; and
receiving a confirmation message indicating reception of the message including the parameter from the UE.

8. The method according to claim 7, further comprising:
if the confirmation message is not received, retransmitting the message including the parameter associated with the updated identifier.

9. The method according to claim 8, wherein the transmitting includes:
if the confirmation message is not received before expiration of a timer started by transmission of the message including the parameter, retransmitting the message including the parameter associated with the updated identifier to the UE.

10. The method according to claim 7, further comprising:
receiving a request message associated with the location update from the UE.

11. The method according to claim 7, further comprising:
allocating resources for the confirmation message.

12. The method according to claim 7, wherein the confirmation message is transferred through an MSG-ACK message.

13. The method according to claim 7, wherein the message including the parameter is a message related to a location update.

14. The method according to claim 7, wherein the message including the parameter is a message related to a paging.

15. The method according to claim 7, wherein the message including the parameter further includes an indicator for updating the identifier.

16. A user equipment (UE) for updating an identifier of a multicast service shared by group UEs contained in a group zone during an idle state in a wireless access system, comprising:
a radio frequency (RF) unit; and
a controller connected to the RF unit,
wherein the controller controls the RF unit to receive a message including a parameter associated with an updated identifier from a base station (BS), update an identifier based on the updated identifier, and transmit a confirmation message indicating reception of the message including the parameter.
